(19) United States
(12) Patent Application Publication
(10) Pub. No.: US 2014/0292708 A1
(43) Pub. Date: Oct. 2, 2014

(54) TOUCHSCREEN APPARATUS

(71) Applicant: Samsung Electro-Mechanics Co., Ltd., Suwon (KR)

(72) Inventors: Yong Il KWON, Suwon (KR); Tah Joon Park, Suwon (KR); Moon Suk Jeong, Suwon (KR)

(21) Appl. No.: 13/909,487

(22) Filed: Jun. 4, 2013

(30) Foreign Application Priority Data
Mar. 28, 2013 (KR) 10-2013-0033761

(51) Int. Cl. G06F 3/044

(52) U.S. Cl. CPC G06F 3/044
USPC 345/174

(57) ABSTRACT

There is provided a touchscreen apparatus, including a panel unit including a plurality of driving electrodes extended in a first axial direction and a plurality of sensing electrodes extended in a second axial direction intersecting with the first axial direction, a driving circuit unit applying predetermined inspection signals to a plurality of driving channels electrically connected to the plurality of driving electrodes, and an inspecting unit determining an occurrence of a short between at least one pair of adjacent driving electrodes among the plurality of driving electrodes by performing a logical operation on voltages of the plurality of driving channels.

### CROSS-REFERENCE TO RELATED APPLICATIONS

This application claims the priority of Korean Patent Application No. 10-2013-0033761 filed on Mar. 28, 2013, in the Korean Intellectual Property Office, the disclosure of which is incorporated herein by reference.

### BACKGROUND OF THE INVENTION

1. Field of the Invention

The present invention relates to a touchscreen apparatus.

2. Description of the Related Art

In general, a touchscreen apparatus such as a touchscreen, a touch pad, or the like, an input means attached to a display apparatus to provide an intuitive input method to a user, has recently been widely used in various electronic apparatuses such as cellular phones, personal digital assistants (PDAs), navigation apparatuses, and the like. Particularly, as the demand for smartphones has recently increased, the use of a touchscreen capable of providing various input methods in a limited form factor has correspondingly increased.

Touchscreens used in portable apparatuses may mainly be divided into resistive type touchscreens and capacitive type touchscreens according to a method of sensing a touch input implemented therein. Here, the capacitive type touchscreen has advantages in that it has a relatively long lifespan and various input methods and gestures may be easily used therewith, such that the use thereof has increased. Particularly, capacitive type touchscreens may more easily allow for a multi-touch interface as compared with resistive type touchscreens, such that they are widely used in apparatuses such as smartphones, and the like.

Capacitive type touchscreens include a plurality of electrodes having a predetermined pattern and defining a plurality of nodes in which capacitance changes are generated by a touch input. In the plurality of nodes distributed on a two-dimensional plane, a self-capacitance or mutual-capacitance change is generated by the touch input. A coordinate of the touch input may be calculated by applying a weighted average method, or the like, to the capacitance change generated in the plurality of nodes.

However, the plurality of electrodes are arranged to have significantly narrow micro-gaps therebetween, such that a short may be generated between adjacent electrodes of the plurality of electrodes. When a short is generated between the adjacent electrodes, the touch may not be correctly determined.

Patent Document 1, which relates to an inspection apparatus for a touch panel, discloses a method of inspecting a disconnection and a short in the touch panel using a plurality of capacitive non-contact type probes and contact type probes scanning interface terminal units. However, Patent Document 1 does not disclose a method of inspecting shorts in a touch panel without using an external inspection apparatus such as the probe.

### RELATED ART DOCUMENT

(Patent Document 1) Korean Patent Laid-Open Publication No. 10-2011-0083196

### SUMMARY OF THE INVENTION

An aspect of the present invention provides a touchscreen apparatus capable of inspecting whether or not a short has been generated in a touch panel without using an external inspection apparatus.

According to an aspect of the present invention, there is provided a touchscreen apparatus, including: a panel unit including a plurality of driving electrodes extended in a first axial direction and a plurality of sensing electrodes extended in a second axial direction intersecting with the first axial direction; a driving circuit unit applying predetermined inspection signals to a plurality of driving channels electrically connected to the plurality of driving electrodes; and an inspecting unit determining an occurrence of a short between at least one pair of adjacent driving electrodes among the plurality of driving electrodes by performing a logical operation on voltages of the plurality of driving channels.

The inspection signals may have different voltage levels for adjacent driving channels among the plurality of driving channels.

The inspecting unit may include: a logical operating unit performing a logical operation on the voltages measured in adjacent driving channels among the plurality of driving channels; and a determining unit determining the occurrence of the short between the at least one pair of adjacent driving electrodes among the plurality of driving electrodes according to a signal output from the logical operating unit.

The logical operating unit may perform an exclusive OR operation on the voltages measured in the adjacent driving channels.

The determining unit may determine that the short is generated between the at least one pair of adjacent driving electrodes when the signal output from the logical operating unit has a low level.

According to another aspect of the present invention, there is provided a touchscreen apparatus, including: a panel unit including a plurality of driving electrodes extended in a first axial direction and a plurality of sensing electrodes extended in a second axial direction intersecting with the first axial direction; a sensing circuit unit applying predetermined inspection signals to a plurality of sensing channels electrically connected to the plurality of sensing electrodes; and an inspecting unit determining an occurrence of a short between at least one pair of adjacent sensing electrodes among the plurality of sensing electrodes by performing a logical operation on voltages of the plurality of sensing channels.

The inspection signals may have different voltage levels for adjacent sensing channels among the plurality of sensing channels.

The sensing circuit unit may include a plurality of integrating circuit units, each integrating circuit unit including a first switch, a second switch disposed between the sensing channel and a ground terminal, an operational amplifier having an inverting terminal connected to one terminal of the first switch and a non-inverting terminal connected to a common voltage terminal, and a feedback capacitor disposed between an output terminal and the inverting terminal of the operational amplifier, the other terminal of the first switch included in each of the plurality of integrating circuit units may be connected to each of the plurality of sensing channels, and the first switch and the second switch of two integrating circuit units among plurality of integrating circuit units, connected to the adjacent sensing channels among the plurality of sensing channels, may perform different switching operations.

The inspecting unit may include: a logical operating unit performing a logical operation on the voltages measured in adjacent sensing channels among the plurality of sensing channels; and a determining unit determining the occurrence of the short between the at least one pair of adjacent sensing electrodes among the plurality of sensing electrodes according to signal output from the logical operating unit.

The logical operating unit may perform an exclusive OR operation on the voltages measured in the adjacent sensing channels.

The determining unit may determine that the short is generated between the at least one pair of adjacent sensing electrodes when the signal output from the logical operating unit has a low level.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing the exterior of an electronic apparatus including a touchscreen apparatus according to an embodiment of the present invention;

FIG. 2 is a view showing a panel unit capable of being included in the touchscreen apparatus according to the embodiment of the present invention;

FIG. 3 is a view showing a cross-section of the panel unit shown in FIG. 2;

FIG. 4 is a view showing a touchscreen apparatus according to an embodiment of the present invention;

FIG. 5 is a view showing the touchscreen apparatus for inspecting whether or not a short is generated between a plurality of first electrodes according to the embodiment of the present invention; and

FIG. 6 is a view showing the touchscreen apparatus for inspecting whether or not a short is generated between a plurality of second electrodes according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

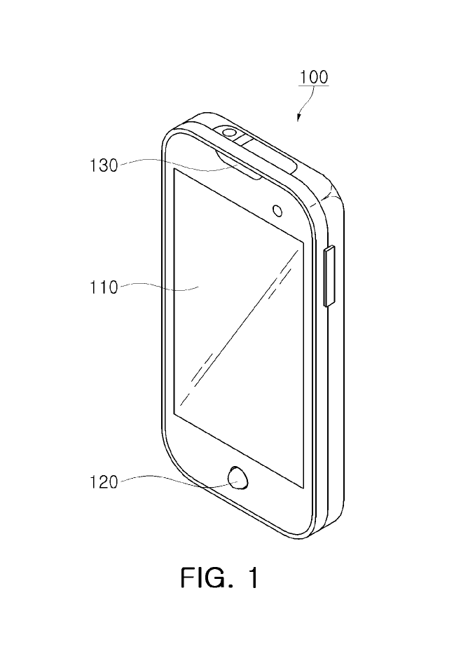

FIG. 1 is a perspective view showing the exterior of an electronic apparatus including a touchscreen apparatus according to an embodiment of the present invention.

Referring to FIG. 1, an electronic apparatus 100 according to the present embodiment may include a display apparatus 110 for outputting a screen therethrough, an input unit 120, an audio unit 130 for outputting a sound, and the like, and may be integrated with the display apparatus 110 to provide a touchscreen apparatus.

As shown in FIG. 1, in general, a mobile apparatus may be configured in such a manner that a touchscreen apparatus is integrated with a display apparatus, and the touchscreen apparatus may have a high degree of light transmissivity to which an image passes through a screen displayed on the display apparatus. Thus, the touchscreen apparatus may be manufactured by forming an electrode on abase substrate formed of a transparent film material such as polyethylene terephthalate (PET), polycarbonate (PC), polyethersulfone (PES), polyimide (PI) or the like, the electrode being formed of an electrically conductive transparent material such as indium-tin oxide (ITO), indium zinc oxide (IZO), zinc oxide (ZnO), carbon nanotubes (CNT) or graphene. A wiring pattern connected to the electrode formed of a transparent conductive material is formed in a bezel region of the display apparatus. Since the wiring pattern is visually shielded by the bezel region, the wiring pattern may also be formed of a metal such as silver (Ag), copper (Cu), or the like.

The touchscreen apparatus according to an embodiment of the present invention may be a capacitive type touchscreen apparatus and accordingly, it may include a plurality of electrodes having a predetermined pattern. Also, the touchscreen apparatus according to an embodiment of the present invention may include a capacitance detection circuit detecting changes in capacitance generated in the plurality of electrodes, an analog-to-digital conversion circuit converting an output signal from the capacitance detection circuit into a digital value, an operation circuit determining a touch input by using data converted as the digital value, and the like.

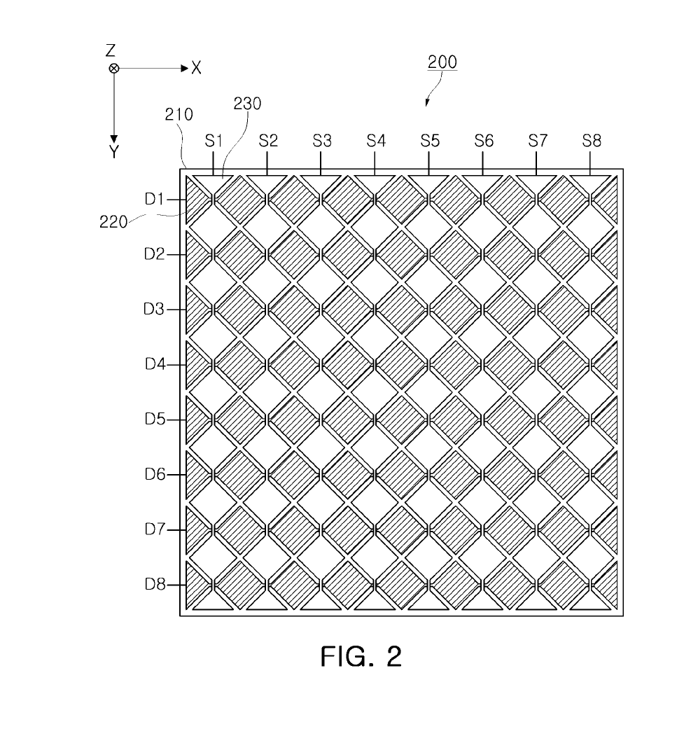

FIG. 2 is a view showing a panel unit capable of being included in the touchscreen apparatus according to the embodiment of the present invention.

Referring to FIG. 2, a panel unit 200 according to the present embodiment includes a substrate 210 and a plurality of electrodes 220 and 230 provided on the substrate 210. Although not shown in FIG. 2, the plurality of electrodes 220 and 230 may be respectively electrically connected with wiring patterns of a circuit board, which is bonded to one end of the substrate 210, through wirings and bonding pads. A controller integrated circuit is mounted on the circuit board to detect a sensing signal generated from the plurality of electrodes 220 and 230 and determine a touch input from the sensing signal.

In the case of the touchscreen apparatus, the substrate 210 may be a transparent substrate on which the plurality of electrodes 220 and 230 are formed, and may be formed of a plastic material such as polyimide (PI), polymethylmethacrylate (PMMA), polyethyleneterephthalate (PET), or polycarbonate (PC), or tempered glass. Further, with respect to a region in which the wirings connected to the plurality of electrodes 220 and 230 are formed, except for a region in which the plurality of electrodes 220 and 230 are formed, a predetermined printing region may be formed on the substrate 210 in order to visually shield the wirings generally formed of an opaque metal material.

The plurality of electrodes 220 and 230 may be provided on one surface or both surfaces of the substrate 210. The touchscreen apparatus may be formed of indium tin-oxide (ITO), indium zinc-oxide (IZO), zinc oxide (ZnO), carbon nano tube (CNT), a graphene based material, or the like, having transparency and conductivity. In FIG. 2, the plurality of electrodes 220 and 230 having a diamond-like pattern are illustrated, but the present invention is not limited thereto and the electrodes 220 and 230 may have various polygonal patterns such as a rectangular pattern, a triangular pattern, or the like.

The plurality of electrodes 220 and 230 include the first electrodes 220 extending in an X-axis direction and the second electrodes 230 extending in a Y-axis direction. The first electrodes 220 and the second electrodes 230 may intersect each other on both surfaces of the substrate 210, or on different substrates 210. In the case in which the first electrodes 220 and the second electrodes 230 are all formed on one surface of the substrate 210, predetermined insulating layers may be partially formed in intersections between the first electrodes 220 and the second electrodes 230.

The touchscreen apparatus, electrically connected to the plurality of electrodes 220 and 230 to sense a touch input, may detect changes in capacitance generated from the plurality of electrodes 220 and 230 according to a touch input applied thereto and sense the touch input therefrom. The first electrodes 220 may be connected to channels defined as D1 to D8 in the controller integrated circuit to thereby receive predetermined driving signals, and the second electrodes 230 may be connected to channels defined as S1 to S8 to thereby be used for the touchscreen apparatus to detect a sensing signal. Here, the controller integrated circuit may detect, as a sensing signal, changes in mutual-capacitance generated between the first electrodes 220 and the second electrodes 230, and may be operated in such a manner that driving signals are sequentially applied to the respective first electrodes 220 and the changes in capacitance are simultaneously detected by the second electrodes 230.

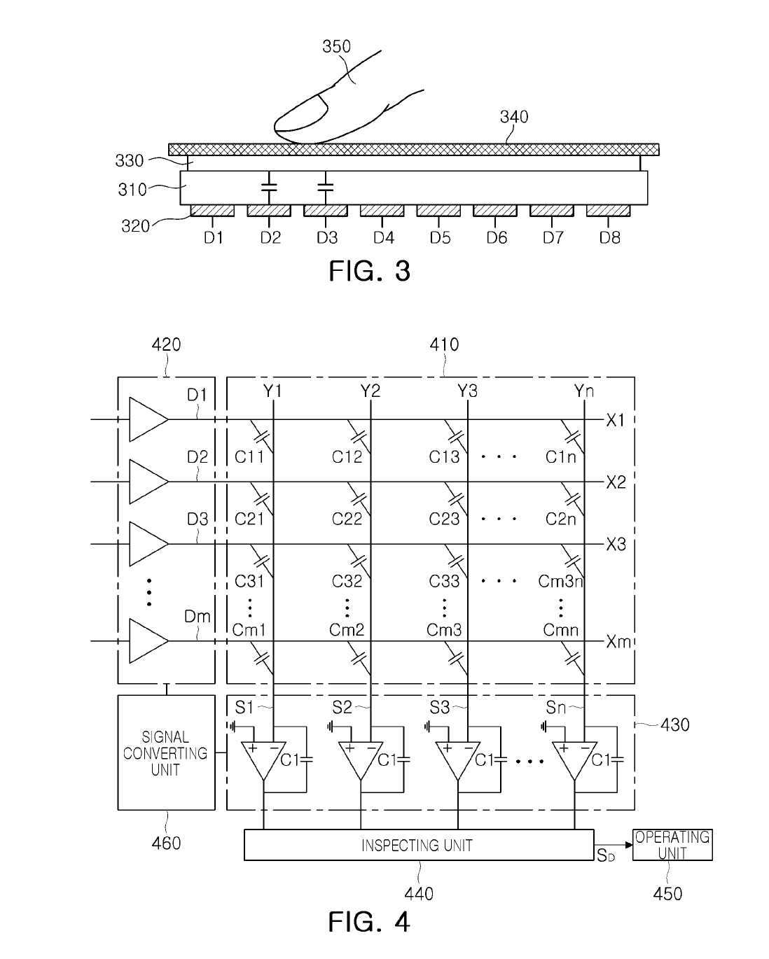

FIG. 3 is a view showing a cross-section of the panel unit shown in FIG. 2. FIG. 3 is a cross-sectional view of the panel unit 200 illustrated in FIG. 2, taken along Y-Z plane, and the panel unit 200 may include a substrate 310 and a plurality of electrodes 320 and 330 as described above with reference to FIG. 2 and further include a cover lens 340 receiving contact. The cover lens 340 may be disposed on the second electrode 330 used for detecting a sensing signal and receive a touch input from a contact object 350 such as a finger, or the like.

When driving signals are sequentially applied to the first electrodes 320 through the channel D1 to D8, mutual capacitance may be generated between the first electrodes 320 to which the driving signals are applied and the second electrode 330. When the driving signals are sequentially applied to the first electrodes 320, changes in mutual capacitance generated between the first electrodes 320 and the second electrode 330 adjacent to a region with which the contact object 350 is brought into contact may be caused. The changes in capacitance may be proportional to the area of an overlapping region between the contact object 350 and the first electrodes 320 to which the driving signals are applied and the second electrode 330. In FIG. 3, mutual capacitance generated between the first electrodes 320 and the second electrode 330 connected to the channels D2 and D3 is affected by the contact object 350.

FIG. 4 is a view showing a touchscreen apparatus according to an embodiment of the present invention. Referring to FIG. 4, the touchscreen apparatus according to the present embodiment may include a panel unit 410, a driving circuit unit 420, a sensing circuit unit 430, a signal converting unit 440, an operating unit 450, and an inspecting unit 460.

The panel unit 410 may include a plurality of first electrodes X1 to Xm extended in a first axial direction, that is, a horizontal direction of FIG. 4 and a plurality of second electrodes Y1 to Yn extended in a second axial direction, that is, a vertical direction of FIG. 4, intersecting with the first axial direction. Changes in capacitance C11 to Cmn are generated in intersections between the first electrodes X1 to Xm and the second electrodes Y1 to Yn. The changes in capacitance C11 to Cmn generated in the intersections between the first electrodes X1 to Xm and the second electrodes Y1 to Yn may be changes in mutual capacitance generated by driving signals applied to the first electrodes X1 to Xm by the driving circuit unit 420. Meanwhile, the driving circuit unit 420, the sensing circuit unit 430, the signal converting unit 440, the operating unit 450, and the inspecting unit 460 may be implemented as a single integrated circuit (IC).

The driving circuit unit 420 may apply predetermined driving signals to the first electrodes X1 to Xm of the panel unit 410 through driving channels D1 to Dm. The driving signals may be square wave signals, sine wave signals, triangle wave signals, or the like, having a predetermined period and amplitude and be sequentially applied to each of the plurality of first electrodes X1 to Xm. Although the case in which circuits for generating and applying the driving signals are individually connected to the plurality of first electrodes X1 to Xm is shown in FIG. 4, a single driving signal generating circuit may also generate driving signals and apply the generated driving signals to the plurality of first electrodes X1 to Xm, respectively, using a switching circuit. The plurality of first electrodes X1 to Xm may be referred to as a plurality of driving electrodes.

The sensing circuit unit 430 may include an integrating circuit for sensing the changes in capacitance C11 to Cmn generated in a plurality of nodes, and the integrating circuit may be connected to the plurality of second electrodes Y1 to Yn through sensing channels S1 to Sn. The integrating circuit may include at least one operational amplifier and a capacitor C1 having a predetermined degree of capacitance, and in this case, the operational amplifier has an inverting input terminal connected to the second electrodes Y1 to Yn to convert the changes in capacitance C11 to Cmn into analog signals such as voltage signals, or the like, and then output the analog signals. A detailed configuration of the integrating circuit included in the sensing circuit unit 430 will be described below. In the case in which the driving signals are sequentially applied to the plurality of first electrodes X1 to Xm, respectively, since the changes in capacitance may be simultaneously detected in the plurality of second electrodes Y1 to Yn, the number of integrating circuits may correspond to the number (n) of second electrodes Y1 to Yn. The plurality of second electrodes Y1 to Yn may be referred to as a plurality of sensing electrodes.

The signal converting unit 440 may generate a digital signal S_{D} from an analog signal generated by the integrating circuit. As an example, the signal converting unit 440 may include a time-to-digital converter (TDC) circuit for measuring a period of time for which an analog signal in a voltage form output from the sensing circuit unit 430 reaches a predetermined reference voltage level and converting the period of time into the digital signal S_{D} or an analog-to-digital converter (ADC) circuit for measuring an amount by which a level of the voltage output from the sensing circuit unit 430 is changed for a predetermined period of time and converting the amount into the digital signal S_{D}.

The operating unit 450 may determine a touch input applied to the panel unit 410 using the digital signal S_{D}. As an example, the operating unit 450 may determine the number of touch inputs applied to the panel unit 410, coordinates of the touch input, a gesture based on the touch input, or the like. The digital signal S_{D} basically used in determining the touch input by the operating unit 450 may be data digitizing the changes in capacitance C11 to Cmn, and particularly, may be data representing a difference in capacitance between a case in which the touch input is not generated and a case in which the touch input is generated. Typically, in a capacitive type touchscreen apparatus, it may be appreciated that the region with which a conductive object comes into contact has a lower level of capacitance than the region in which the contact is not generated.

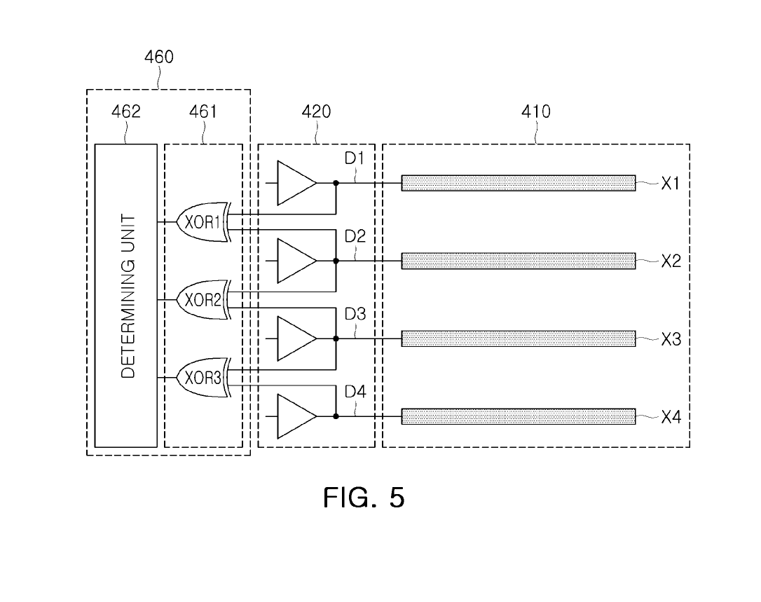

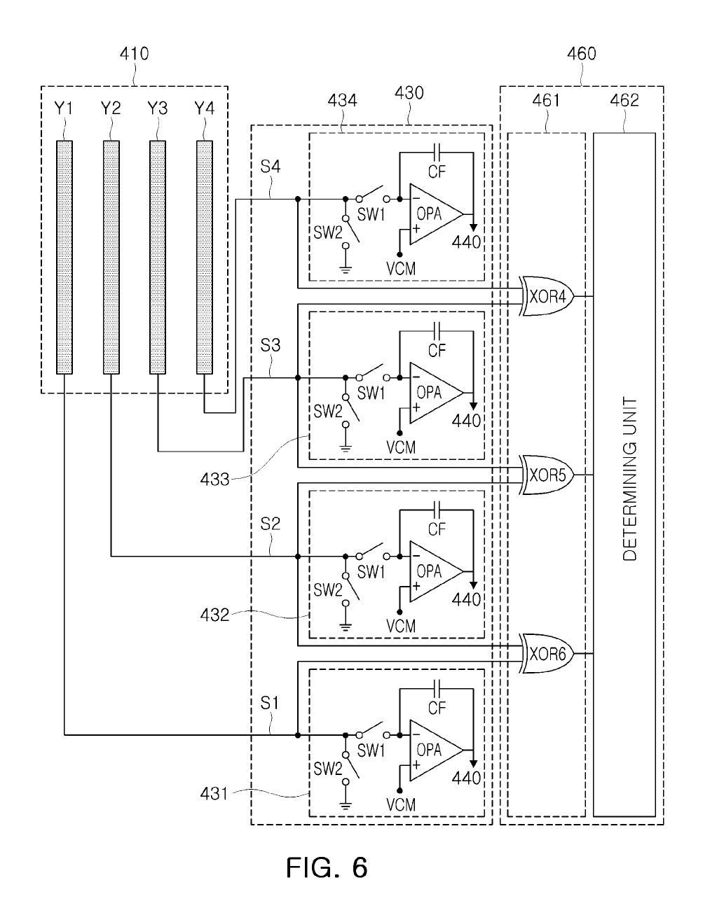

The inspecting unit 460 may inspect whether or not a short is generated between the adjacent first electrodes among the plurality of first electrodes X1 to Xm of the panel unit or whether or not the short is generated between the adjacent second electrodes among the plurality of second electrodes Y1 to Yn. The inspecting unit 460 may be electrically connected to a plurality of channels connected to the plurality of first electrodes X1 to Xm and the plurality of second electrodes Y1 to Yn, respectively, to measure voltages of the plurality of channels and logically operate the measured voltages, thereby determining whether or not the short is generated. A detailed configuration of the inspecting unit 460 may be provided with reference to FIGS. 5 and 6, and the touchscreen apparatus of FIG. 4 will be described in more detail with reference to FIGS. 5 and 6.

FIG. 5 is a view showing the touchscreen apparatus for inspecting whether or not a short is generated between a plurality of first electrodes according to the embodiment of the present invention. In FIG. 5, a portion of the touchscreen apparatus illustrated in FIG. 4, in which whether or not a short is generated between a plurality of first electrodes is inspected, may be shown in detail, while the same portions thereof as those of FIG. 4 are briefly represented or omitted.

Referring to FIG. 5, the touchscreen apparatus according to the embodiment of the present invention may include the panel unit 410, the driving circuit unit 420, and the inspecting unit 460. The panel unit 410, the driving circuit unit 420, and the inspecting unit 460 of FIG. 5 are the same components as the panel unit 410, the driving circuit unit 420, and the inspecting unit 460 of FIG. 4. Therefore, differences between the components will be mainly described. FIG. 5 shows the panel unit 410 in which the plurality of second electrodes of the panel unit 410 illustrated in FIG. 4 are omitted and shows only four first electrodes X1 to X4 for convenience of explanation.

In the case in which the touchscreen apparatus according to the embodiment of the present invention inspects whether or not a short is generated between the plurality of first electrodes, the inspecting unit 460 measures voltages of a plurality of driving channels D1 to D4 electrically connected to a plurality of first electrodes X1 to X4. Although not shown in FIG. 5, since the plurality of driving channels D1 to D4 may be electrically connected to the plurality of first electrodes X1 to X4 through bonding pads and wirings, voltages of the plurality of respective first electrodes X1 to X4 may be maintained in the same levels as those of the plurality of driving channels D1 to D4. Therefore, the inspecting unit 460 may measure voltages of the plurality of first electrodes X1 to X4 by measuring voltages of the plurality of driving channels D1 to D4.

In this case, in order for the inspecting unit 460 to determine whether or not a short is generated between the plurality of first electrodes, the driving circuit unit 420 applies signals having different voltage levels, that is, inspection signals to adjacent driving channels. For example, in the case in which a high level voltage is applied to an even numbered channel, a low level voltage may be applied to an odd numbered channel. In addition, on the other hand, in the case in which the low level voltage is applied to the even numbered channel, the high level voltage may be applied to the odd numbered channel. Although not shown in FIG. 5, it is assumed that the sensing circuit unit 430 of FIG. 4 is not operated when it is determined whether or not a short is generated between the plurality of first electrodes.

In the case in which the short is generated between the plurality of first electrodes X1 to X4, voltage levels of the adjacent first electrodes between which the short is generated are the same and in this case, the inspecting unit 460 may inspect whether or not the short is generated between the plurality of first electrodes X1 to X4 by performing a logical operation on voltages of the adjacent first electrodes. The inspecting unit 460 may include a logical operating unit 461 and a determining unit 462. The logical operating unit 461 may include logic gates XOR1 to XOR3 to perform an exclusive OR operation on the voltages measured in the plurality of driving channels adjacent to each other, and the determining unit 462 may determine the occurrence of a short that may be generated between the adjacent first electrodes of the plurality first electrodes X1 to X4 from signals output from the logic gates XOR1 to XOR3.

For example, the description is made on the assumption that the driving circuit unit 420 applies the high level voltage to the odd numbered channel and applies the low level voltage to the even numbered channel. In the case in which the short is not generated between the first electrodes, the logical gates XOR1 to XOR3 respectively output high level signals and the determining unit 462 determines that the short is not generated between the first electrodes X1 to X4, from the signals output from the logical gates XOR1 to XOR3.

On the other hand, in the case in which the short is generated between the first electrode X2 and the first electrode X3 among the first electrodes X1 to X4, since a high level voltage is measured in the channel D1 while low level voltages are measured in the channels D2 to D4, the logical gate XOR1 outputs a high signal and the logical gates XOR2 and XOR3 output low signals. The determining unit 462 may determine that a short has been generated between at least one pair of adjacent electrodes among the first electrodes X2 to X4, from the low signals output from the logic gates XOR2 and XOR3.

FIG. 6 is a view showing the touchscreen apparatus for inspecting whether or not a short is generated between a plurality of second electrodes according to the embodiment of the present invention. In FIG. 6, a portion of the touchscreen apparatus illustrated in FIG. 4, in which whether or not a short is generated between a plurality of second electrodes is inspected, may be shown in detail, while the same portions thereof as those of FIG. 4 are briefly represented or omitted.

Referring to FIG. 6, the touchscreen apparatus according to the embodiment of the present invention may include the panel unit 410, the driving circuit unit 430, and the inspecting unit 460. The panel unit 410, the sensing circuit unit 430, and the inspecting unit 460 of FIG. 6 are the same components as the panel unit 410, the sensing circuit unit 430, and the inspecting unit 460 of FIG. 4. Therefore, differences between the components will be mainly described. FIG. 6 shows the panel unit 410 in which the plurality of first electrodes of the panel unit 410 illustrated in FIG. 4 are omitted and shows only four second electrodes Y1 to Y4 for convenience of explanation.

As shown in FIG. 6, the sensing circuit unit 430 may include a plurality of integrating circuit units 431 to 434, each integrating circuit unit including a first switch SW1 having the other terminal connected to a sensing channel, a second switch SW2 disposed between the sensing channel and a ground terminal, an operational amplifier OPA having an inverting terminal connected to one terminal of the first switch SW1 and a non-inverting terminal connected to a common voltage (VCM) terminal, and a feedback capacitor CF disposed between an output terminal and the inverting terminal of the operational amplifier OPA. The integrating circuit units 431 to 434 may respectively receive charges stored in node capacitors formed in intersections between the plurality of first electrodes and the plurality of second electrodes Y1 to Y4 and then integrate the received charges in the operational amplifier OPA and the feedback capacitor CF, thereby detecting the changes in capacitance that may be generated in the node capacitors. The analog signal generated from each of the integrating circuit units 431 to 434 may be transferred to the signal converting unit 440 of FIG. 4 as described above.

In the case in which the touchscreen apparatus according to the embodiment of the present invention inspects whether or not a short is generated between the plurality of second electrodes, the inspecting unit 460 measures voltages of a plurality of sensing channels S1 to S4 electrically connected to a plurality of second electrodes Y1 to Y4. Although not shown in FIG. 6, since the plurality of sensing channels S1 to S4 may be electrically connected to the plurality of second electrodes Y1 to Y4 through bonding pads and wirings, voltages of the plurality of second electrodes Y1 to Y4 may be maintained in the same levels as those of the plurality of sensing channels S1 to S4. Therefore, the inspecting unit 630 may measure the voltages of the plurality of second electrodes Y1 to Y4 by measuring voltages of the plurality of sensing channels S1 to S4.

In this case, the sensing circuit unit 430 provides predetermined inspection signals to the adjacent sensing channels in order to apply different level voltages to the adjacent sensing channels. To this end, the first switch and the second switch of two integrating circuit units connected to the adjacent sensing channels perform different switching operations. For example, in the case in which a high level voltage is applied to the odd numbered channel and a low level voltage is applied to the even numbered channel, the switches SW1 of the integrating circuit units 431 and 433 are switched on and the switches SW2 thereof are switched off, and the switches SW1 of the integrating circuit units 432 and 434 are switched off and the switches SW2 thereof are switched on. On contrary to this, in the case in which a low level voltage is applied to the odd numbered channel and a high level voltage is applied to the even numbered channel, the switches SW2 of the integrating circuit units 431 and 433 are switched on and the switches SW1 are switched off, and the switches SW2 of the integrating circuit units 432 and 434 are switched off and the switches SW1 thereof are switched on. In this case, it is assumed that the level of the common voltage (VCM) is a level that could be recognized by the logic gates XOR4 to XOR6 as the high level voltage. In addition, although not shown in FIG. 6, it is assumed that the driving circuit unit 420 of FIG. 4 maintains all of the plurality of first electrodes at the same potential.

In the case in which the short is generated between the plurality of second electrodes Y1 to Y4, voltage levels of the adjacent second electrodes between which the short is generated are the same and in this case, the inspecting unit 460 may inspect whether or not the short is generated between the plurality of second electrodes Y1 to Y4 by performing a logical operation on voltages of the adjacent second electrodes. The inspecting unit 460 may include the logical operating unit 461 and the determining unit 462. The logical operating unit 461 may include logic gates XOR4 to XOR6 to perform an exclusive OR operation on the voltages measured in the plurality of driving channels adjacent to each other, and the determining unit 462 may determine the occurrence of a short that may be generated between the adjacent second electrodes of the plurality second electrodes Y1 to Y4 from signals output from the logic gates XOR4 to XOR6.

For example, the description is made on the assumption that a high level signal is applied to the odd numbered channel and a low level signal is applied to the even numbered channel. In the case in which the short is not generated between the second electrodes, the logical gates XOR4 to XOR6 respectively output high level signals and the determining unit 462 determines that the short is not generated between the second electrodes Y1 to Y4, from the signals output from the logical gates XOR4 to XOR6.

On the other hand, in the case in which the short is generated between the second electrode Y2 and the second electrode Y3 among the second electrodes Y1 to Y4, since a high level voltage is measured in the channel S1 while a low level voltage is measured in the channels S2 to S4, the logical gate XOR4 outputs a high signal and the logical gates XOR5 and XOR6 output low signals. The determining unit 462 may determine that a short has been generated between at least one pair of adjacent electrodes among the second electrodes Y2 to Y4, from the low signals output from the logic gates XOR5 and XOR6.

As set forth above, in the case of the touchscreen apparatus according to the embodiments of the present invention, whether or not a short is generated in a touch panel can be inspected using a simple method without an external inspection apparatus to decrease costs required for inspecting the touch panel.

While the present invention has been shown and described in connection with the embodiments, it will be apparent to those skilled in the art that modifications and variations can be made without departing from the spirit and scope of the invention as defined by the appended claims.

What is claimed is:

1. A touchscreen apparatus, comprising:
a panel unit including a plurality of driving electrodes extended in a first axial direction and a plurality of sensing electrodes extended in a second axial direction intersecting with the first axial direction;
a driving circuit unit applying predetermined inspection signals to a plurality of driving channels electrically connected to the plurality of driving electrodes; and
an inspecting unit determining an occurrence of a short between at least one pair of adjacent driving electrodes among the plurality of driving electrodes by performing a logical operation on voltages of the plurality of driving channels.

2. The touchscreen apparatus of claim 1, wherein the inspection signals have different voltage levels for adjacent driving channels among the plurality of driving channels.

3. The touchscreen apparatus of claim 1, wherein the inspecting unit includes:
a logical operating unit performing a logical operation on the voltages measured in adjacent driving channels among the plurality of driving channels; and
a determining unit determining the occurrence of the short between the at least one pair of adjacent driving electrodes among the plurality of driving electrodes according to a signal output from the logical operating unit.

4. The touchscreen apparatus of claim 3, wherein the logical operating unit performs an exclusive OR operation on the voltages measured in the adjacent driving channels.

5. The touchscreen apparatus of claim 4, wherein the determining unit determines that the short is generated between the at least one pair of adjacent driving electrodes when the signal output from the logical operating unit has a low level.

6. A touchscreen apparatus, comprising:
a panel unit including a plurality of driving electrodes extended in a first axial direction and a plurality of sensing electrodes extended in a second axial direction intersecting with the first axial direction;
a sensing circuit unit applying predetermined inspection signals to a plurality of sensing channels electrically connected to the plurality of sensing electrodes; and
an inspecting unit determining an occurrence of a short between at least one pair of adjacent sensing electrodes among the plurality of sensing electrodes by performing a logical operation on voltages of the plurality of sensing channels.

7. The touchscreen apparatus of claim 6, wherein the inspection signals have different voltage levels for adjacent sensing channels among the plurality of sensing channels.

8. The touchscreen apparatus of claim 7, wherein the sensing circuit unit includes a plurality of integrating circuit units, each integrating circuit unit including a first switch, a second switch disposed between the sensing channel and a ground terminal, an operational amplifier having an inverting terminal connected to one terminal of the first switch and a non-inverting terminal connected to a common voltage terminal, and a feedback capacitor disposed between an output terminal and the inverting terminal of the operational amplifier,
the other terminal of the first switch included in each of the plurality of integrating circuit units is connected to each of the plurality of sensing channels, and
the first switch and the second switch of two integrating circuit units among plurality of integrating circuit units, connected to the adjacent sensing channels among the plurality of sensing channels, perform different switching operations.

9. The touchscreen apparatus of claim 6, wherein the inspecting unit includes:
a logical operating unit performing a logical operation on the voltages measured in adjacent sensing channels among the plurality of sensing channels; and
a determining unit determining the occurrence of the short between the at least one pair of adjacent sensing electrodes among the plurality of sensing electrodes according to signal output from the logical operating unit.

10. The touchscreen apparatus of claim 9, wherein the logical operating unit performs an exclusive OR operation on the voltages measured in the adjacent sensing channels.

11. The touchscreen apparatus of claim 10, wherein the determining unit determines that the short is generated between the at least one pair of adjacent sensing electrodes when the signal output from the logical operating unit has a low level.
